(19) United States
(12) Patent Application Publication
(10) Pub. No.: US 2024/0417612 A1
(43) Pub. Date: Dec. 19, 2024

(54) THERMALLY CONDUCTIVE COMPOSITION FOR HIGH TEMPERATURE APPLICATIONS

(71) Applicant: Henkel AG & Co. KGaA, Duesseldorf (DE)

(72) Inventors: Radesh Jewram, Lakeville, MN (US); Matthew Bren, Waconia, MN (US); Ryan Verhulst, Minneapolis, MN (US)

(21) Appl. No.: 18/817,312

(22) Filed: Aug. 28, 2024

Related U.S. Application Data
(63) Continuation of application No. PCT/US2023/014447, filed on Mar. 3, 2023.
(60) Provisional application No. 63/316,237, filed on Mar. 3, 2022.

(51) Int. Cl. C09K 5/06

(52) U.S. Cl. CPC C09K 5/06

(57) ABSTRACT

A phase-changing thermally conductive composition includes a non-silicone resin and a thermally stable antioxidant having a melting point temperature of between 4° and 85° C. The thermally stable antioxidant acts as a phase-changing component of the composition. The phase-changing thermally conductive composition further includes thermally conductive particulate filler, such that the composition exhibits a thermal conductivity of at least 1 W/m*K and less than 20% weight loss after 1000 hours at 175 ° C.

### FIELD

The present invention relates to thermally conductive compositions generally, and more particularly to a phase changing thermally conductive composition that is stable at high temperatures to limit performance degradation over time.

### BACKGROUND

Thermally conductive materials are widely employed as interfaces between, for example, a heat-generating electronic component and a heat dissipater for permitting transfer of excess thermal energy from the electronic component to a thermally coupled heat dissipater. Numerous designs and materials for such thermal interfaces have been implemented, with the highest performance being achieved when gaps between the thermal interface and the respective heat transfer surfaces are substantially avoided to promote conductive heat transfer from the electronic component to the heat dissipater. The thermal interface materials therefore preferably mechanically conform to the somewhat uneven heat transfer surfaces of the respective components. Moreover, the thermal interface materials are preferably useful over a prolonged lifespan at elevated operating temperatures.

Electronic components such as semiconductors, microprocessors, resistors, and circuit boards generate a substantial amount of heat that must be removed in order for the device to function properly. High performance computing and telecommunication applications generate significant heat, and therefore require thermal interface materials with very low thermal impedance to maximize heat transfer away from sensitive electronic components. One conventional approach for supplying a low impedance interface has been a temperature-activated phase-changing material. The heat of operation of the electronic components raises the temperature in the system above a softening or melting point of a phase-changing component of the thermal interface material. When this happens, the interface viscosity significantly declines to enhance the conformability to the heat transfer surfaces, thereby enhancing the efficiency of heat transfer away for the electronic components. Phase-changing components of thermal interface materials have typically comprised of alkane waxes, including natural waxes, synthetic waxes, and petroleum-based waxes. Paraffin wax is a commonly-used phase-changing component due to its melting point temperature in the range of between about 40° C. and 120° C. However, paraffin wax, and other conventional phase changing components, suffers from degradation at high temperatures experienced in high performance electronic devices. The degradation often includes drying and cracking over prolonged use at high temperatures, which detrimentally impacts thermal performance.

It is therefore an object to increase high temperature stability in a phase-changing thermally conductive composition.

### SUMMARY

By means of the present invention, conventional alkane waxes may be replaced in whole or in part by a dual-function phase-changing component that exhibits high temperature stability, thereby imparting high temperature stability to thermally conductive interface materials in which the dual-function phase-changing component is employed. The dual-function phase-changing component includes a secondary antioxidant having a melting point temperature of between 4° and 85° C.

In one embodiment, the thermally conductive composition includes a non-silicone resin, a primary antioxidant, and a secondary antioxidant that is compatible with the primary antioxidant and present in the composition at a concentration of between 20 and 50 percent by weight of the non-silicone resin. The secondary antioxidant is present in the composition in a ratio of between 95-99 parts by weight secondary antioxidant to between 1-5 parts by weight primary antioxidant. The secondary antioxidant has a melting point temperature of between 4° and 85° C. The thermally conductive composition further includes thermally conductive particulate filler, wherein the composition exhibits a thermal conductivity of at least 1 W/m*K and less than 20% weight loss after 1000 hours at 175° C.

The thermally conductive composition may include between 0.5 and 20 percent by weight of the non-silicone resin. In some embodiments, the thermally conductive composition may include between 0.5 and 5 percent by weight of the non-silicone resin. The non-silicone resin may include a pressure sensitive adhesive. The non-silicone resin may include polyamide.

In some embodiments, the secondary antioxidant may be thiol-based. In some embodiments, the secondary antioxidant may include didodecyl 3,3′-thiodipropionate. In some embodiments, the melting point temperature of the secondary antioxidant may be between 5° and 60° C.

In some embodiments, the composition may include a hydrocarbon wax having a melting point temperature of between 4° and 120° C. In other embodiments, the composition may be substantially free from a wax component.

In some embodiments, the thermally conductive particulate filler is selected from aluminum, aluminum nitride, aluminum silica alloy, zinc oxide, and combinations thereof. The thermally conductive particulate filler may have an average particle size (d₅₀) of less than 25 μm. In some embodiments, the thermally conductive particulate filler comprises between 70 and 95 percent by weight of the composition.

The thermally conductive composition may include a plasticizer. In some embodiments, the plasticizer includes a trimellitate. In some embodiments the trimellitate plasticizer is present in the composition at a concentration of between 0.5 and 20 percent by weight of the composition. In some embodiments, the trimellitate plasticizer is present in the composition at a concentration of between 0.5 and 5 percent by weight of the composition.

The thermally conductive composition may include a wetting agent. In some embodiments, the thermally conductive composition may include between 0.1 and 1.5 percent by weight of the wetting agent.

The thermally conductive composition may include a further antioxidant that is different from the primary and the secondary antioxidants. In some embodiments, the thermally conductive composition may include a sterically hindered phenolic antioxidant that is different from the primary and the secondary antioxidants. In some embodiments, the thermally conductive composition may include between 0.1 and 1.5 percent by weight of the sterically hindered phenolic antioxidant that is different from the primary and the secondary antioxidants.

The thermally conductive composition may include a metal deactivator antioxidant that is different from the primary and the secondary antioxidants. In some embodiments, the thermally conductive composition includes between 0.1 and 1.5 percent by weight of the metal deactivator antioxidant that is different from the primary and secondary antioxidants.

A thermally conductive printable composition includes a non-silicone resin, a primary antioxidant, a thiol-based secondary antioxidant, a thermally conductive particulate filler, and a solvent that is compatible with the remaining components of the composition. The thiol-based secondary antioxidant is compatible with the primary antioxidant and is present in the composition at a concentration of between 20 and 50 percent by weight of the non-silicone resin. The secondary antioxidant may be present in the composition in a ration of between 95-99 parts by weight secondary antioxidant to between 1-5 parts by weight primary antioxidant. The secondary antioxidant may have a melting point temperature of between 4° and 85° C. The thermally conductive particulate filler may be present at between 50 and 98 percent by weight of the composition, wherein the composition exhibits a thermal conductivity of at least 1 W/m*K, and less than 20% weight loss after 1000 hours at 175° C. The composition, dissolved in the solvent, may be printed onto a substrate and dried to form the thermal interface material in thermal contact with the substrate. The composition may be printed onto the substrate by known printing techniques, such as inkjet printing, extrusion through a die, three-dimensional printing, and the like. In some embodiments, the solvent may be selected from ethyl acetate and ethylhexyl acetate.

### DETAILED DESCRIPTION OF THE PREFERRED EMBODIMENTS

Thermally conductive compositions and articles made from such compositions are disclosed. The articles can be used as thermal interfaces between heat-generating components and heat-dissipating devices.

In an example embodiment, an electronic package includes a substrate and one or more electronic components secured to the substrate. The electronic package further includes a heat dissipater, such as a heat sink, and a thermal interface positioned in a thermal pathway between the electronic components and the heat dissipater. The electronic package is arranged to dissipate thermal energy generated by the electronic components by providing a highly thermally conductive path from the electronic components to a heat-absorbing fluid media in contact with the heat dissipater. In typical applications, the fluid media may be a gas, such as air, motivated by an air mover to absorb thermal energy from the heat dissipater. The electronic package may be useful in a variety of electronic applications, such as data processors, data memory, communication boards, antennae, and the like. Such devices may be utilized in computing devices, communication devices, and peripherals therefor. In a particular example, the electronic package may be employed to support various functions in a cellular communication device.

The substrate may serve one or more of a variety of functions in addition to being a support for the electronic components. The substrate may be, for example, a circuit board, such as a printed circuit board with electrically conductive traces on a mounting surface for electrically connecting the electronic components as needed in the assembly. The electronic components may be electrically connected to wiring traces through soldering or other known techniques. In operation, the electronic components typically generate significant excess thermal energy which must be dissipated in order to maintain optimal performance.

The thermal interface provides a thermally conductive bridge between the electronic components and the heat dissipater, which may be thermally coupled to the thermal interface in a manner that most efficiently transmits thermal energy to the heat dissipater.

### Resin

The thermally conductive composition of the present invention may include a non-silicone resin that provides a matrix for incorporating thermally conductive fillers and other additives. Example non-silicone resins useful in the compositions of the present invention may include various thermoplastic materials, including thermoplastic elastomers that may or may not be naturally tacky. Suitable thermoplastic elastomers may include, for example, copolymers including styrenic copolymers such as styrene-butadiene-styrene styrene (SBS), styrene-ethylene/butylene-styrene (SEBS), styrene-isoprene-styrene (SIS), styrene-ethylene/propylene-styrene (SEPS), and combinations thereof. Thermoplastic elastomers also include thermoplastic/elastomer blends and alloys such as non-cross-linked polyolefins that are thermoplastic.

In some embodiments, the resin may include a hydrocarbon resin of one or more rubbers, liquids, and waxes. Example hydrocarbon resins include saturated and unsaturated rubber compounds. Example saturated rubber compounds include ethylene-propylene rubbers, polyethylene/butylene, polyethylene-butylene-styrene, polyethylene-propylene-styrene, hydrogenated polyalkyldiene mono-ols, hydrogenated polyalkyldiene diols, hydrogenated polyisoprene, and polyolefin elastomer.

In some embodiments, silyl-modified resins may be used in the matrices of the present invention. The resins are preferably non-silicone, wherein no more than a trace amount of silicone is contained in the composition. In some embodiments, no silicone is contained in the composition. The silyl-modified polymer may have a flexible backbone for lower modulus and glass transition temperature, such as a backbone of polyether, polyester, polyurethane, polyacrylate, polyisoprene, polybutadiene, polystyrene-butadiene, or polybutylene isoprene.

In some embodiments, the resin may include one or more pressure sensitive adhesives. As used herein, the term “pressure sensitive adhesive” or “PSA” refers to a viscoelastic material which adheres instantaneously to most substrates with the application of slight pressure and remains permanently tacky. A polymer is a PSA within the meaning of the term as used herein if it has the properties of a PSA per se or functions as a PSA by admixture with diluent and other additives. Example pressure sensitive adhesives include block copolymers, such as the styrenic copolymers described above, tackifying resins, and plasticizers. Pressure sensitive adhesives may have certain rheological characteristics that are beneficial to the compositions of the present invention, including a low softening point and a low molten viscosity in combination with high cohesive strength. Due to the low viscosity at low application temperatures, the adhesive resin component may be amenable to application methods wherein a coating device contacts the substrate being coated such as in the case of screen printing and engraved roll coating.

The resin may be present in a range of about 0.1 up to about 50 percent by weight of the total composition; in some embodiments, the resin may be present in the range of about 0.5 up to about 20 percent by weight of the total composition; in some embodiments, the resin may be present in the range of about 0.5 up to about 10 percent by weight of the total composition; in some embodiments, the resin may be present in the range of about 0.5 up to about 5 percent by weight of the total composition; in some embodiments, the resin may be present in the range of 1 up to 3 percent by weight of the total composition.

### Antioxidant Phase Change Material

The compositions of the present invention are preferably phase-changing, in that they include a phase changing material having a melting point temperature or temperature range within or below an operating temperature or temperature range of the electronic components to which the thermally conductive material may be thermally coupled. The temperature-activated phase changing material preferably changes from a solid state to a liquid state and from a liquid state to a solid state within a temperature range of about 30° C. to about 160° C., and more preferably between 40° C. and 85° C. The phase changing material used in conventional compositions often includes materials such as a natural wax like beeswax or carnuba wax, a petroleum-based wax like paraffin wax, or a synthetic wax like polyethylene glycol, polyethylene, polyhydric alcohols, or chlorinated naphthalene.

An exemplary conventional phase change material is a wax, such as a paraffin wax. Paraffin waxes are a mixture of solid hydrocarbons having the general formula CₙH₂ₙ₊₂ and having melting points in the range of about 40° C. to about 140° C., and more preferably in the range of 40° C. to 80° C. Polymer waxes include polyethylene waxes and polypropylene waxes, and typically have a range of melting point from about 40° C. to about 160° C.

As described herein, conventional phase changing materials such as waxes tend to suffer from degradation at the high temperatures often experienced in modern electronic packages. Applicant has found that a high-performance phase-changing thermally conductive composition may be achieved by replacing some or all of the conventional phase changing materials with a low-melting point secondary antioxidant. Although secondary antioxidants have been used in thermal materials, it is believed to be a novel approach to employ a secondary antioxidant to drive phase-changing behavior in a thermally conductive composition. It has been discovered that such low-melting point secondary antioxidants are capable of both performing the phase-changing role in a thermally conductive composition and improving the high-temperature reliability of such compositions.

In some embodiments, the phase-changing antioxidant component is a secondary antioxidant that is used in connection with, and compatible with, a primary antioxidant. Secondary antioxidants retard oxidation by preventing the proliferation of alkoxy and hydroxyl radicals by decomposing hydroperoxides to yield nonreactive products. Primary antioxidants function by donating their reactive hydrogen to the peroxy free radical so that the propagation of subsequent free radicals does not occur. The antioxidant free radical is rendered stable by electron delocalization. In some embodiments, the secondary antioxidant is thiol-based, such as a thioester. An example thiol-based secondary antioxidant is didodecyl 3,3′-thiodipropionate, having a melting point temperature of between 4° and 85° C. In some embodiments, the compatible primary antioxidant is a phenolic antioxidant. Phenolic antioxidants include simple phenolics, bisphenol s, polyphenolics, and thiobis phenolics.

It has been found that a concentration of the secondary antioxidant within a concentration range of the thermally conductive composition is important to maintain the functionality of the composition, and particularly a relative concentration of the secondary antioxidant with respect to the resin. Preferably, the secondary antioxidant is present in the composition at a concentration of between 20 and 50 percent by weight of the non-silicone resin. Although the secondary antioxidant may preferably have a melting point temperature of between 4° and 85° C. to suitably act as a phase-changing component, the secondary antioxidant may more preferably have a melting point temperature of between 5° and 60° C.

The secondary antioxidant may be present in the composition in a ratio of between 95-99 parts by weight secondary antioxidant to between 1-5 parts by weight primary antioxidant. In some embodiments, the secondary antioxidant may be present in the composition in a ratio of between 97-99 parts by weight secondary antioxidant to between 1-3 parts by weight primary antioxidant.

In some embodiments, the thermally conductive composition of the present invention is substantially free from a wax component. In other embodiments, however, the thermally conductive composition includes a wax component. In some embodiments, the wax component is a hydrocarbon wax. In some embodiments, the hydrocarbon wax has a melting point temperature of between 4° and 120° C. In some embodiments, the hydrocarbon wax has a melting point temperature of between 4° and 80° C. In some embodiments, the hydrocarbon wax is paraffin wax.

### Thermally Conductive Particles

In order to achieve the desired low thermal impedance of the thermally conductive interface, the compositions of the present invention include thermally conductive particles dispersed therein. The particles may be both thermally conductive and electrically conductive. Alternatively, the particles may be thermally conductive and electrically insulating. Various thermally conductive particles may be useful in the compositions of the present invention. It has been found, however, that thermally conductive particles selected from aluminum, aluminum nitride, aluminum silica alloy, zinc oxide, and combinations thereof may be most useful in the compositions of the present invention.

The particulate filler material may be in the form granular powder, whiskers, fibers, or any other suitable form. The particles may be substantially spherical, plate-like, rod-like, or a combination thereof. In some embodiments, the thermally conductive particles may have a particle size of less than 25 μm, with the term “particle size” meaning particle diameter or effective particle diameter. In some embodiments, the thermally conductive particles may have a particle size of between 0.01 and 25 μm. In some embodiments, the thermally conductive particles may be monodispersed.

In some embodiments, the thermally conductive particles, which may comprise one or more material species, may have a particle size distribution with particles having a particle size of between 0.01 and 25 μm.

In some embodiments, the particle size distribution may be multi-modal, with more than one concentration peak of particle sizes of between 0.01 and 25 μm. In some embodiments, a first concentration peak of the multi-modal distribution is a particle size of between 0.1 and 3 μm, and a second concentration peak of the multi-modal distribution is a particle size of between 8 and 12 μm. The first concentration peak of the multi-modal distribution may comprise between 10 and 90 percent by weight of the total thermally conductive filler; in some embodiments, the first concentration peak of the multi-modal distribution may comprise between 15 and 80 percent by weight of the total thermally conductive filler; in some embodiments, the first concentration peak of the multi-modal distribution may comprise between 15 and 50 percent by weight of the total thermally conductive filler; in some embodiments, the first concentration peak of the multi-modal distribution may comprise between 15 and 30 percent by weight of the total thermally conductive filler. The second concentration peak of the multi-modal distribution may comprise between 10 and 90 percent by weight of the total thermally conductive filler; in some embodiments, the second concentration peak of the multi-modal distribution may comprise between 15 and 80 percent by weight of the total thermally conductive filler; in some embodiments, the second concentration peak of the multi-modal distribution may comprise between 25 and 60 percent by weight of the total thermally conductive filler. The multi-modal distribution may include more than two concentration peaks of particle sizes.

In some embodiments, the thermally conductive particulate filler may comprise a tri-modal particle size distribution of particle sizes between 0.01 and 25 μm. A first concentration peak of the tri-modal distribution is an aluminum nitride particle size of between 0.1 and 3 μm, a second concentration peak of the tri-modal distribution is an aluminum or aluminum-silica alloy (silica stabilized aluminum) particle size of between 8 and 12 μm, and a third concentration peak of the tri-modal distribution is a zinc oxide particle size of between 0.01 and 0.5 μm. The first concentration peak of the tri-modal distribution comprises between 15 and 35 percent by weight of the total thermally conductive filler. The second concentration peak comprises between 25 and 60 percent by weight of the total thermally conductive filler. The third concentration peak comprises between 15 and 35 percent by weight of the total thermally conductive filler.

The thermally conductive particulate filler may comprise at least 25 percent by weight aluminum and/or aluminum-silica alloy particles, preferably at least 35 percent by weight aluminum and/or aluminum-silica alloy particles, and more preferably at least 40 percent by weight aluminum and/or aluminum-silica alloy particles.

In some embodiments, the particle sizes described above may represent average particle diameters (d₅₀).

The thermally conductive particulate filler may be dispersed in the resin and present in the composition at a loading concentration of between 20 and 98 percent by weight of the total composition. In some embodiments, the thermally conductive particulate filler comprises between 40 and 97 percent by weight of the total composition. In some embodiments, the thermally conductive particulate filler comprises between 50 and 95 percent by weight of the total composition. It is desirable that sufficient thermally conductive particles are provided so that the thermally conductive interface formed from the composition exhibits a thermal conductivity of at least 0.5 W/m*K, preferably at least 1 W/m*K, and more preferably at least 2 W/m*K.

### Plasticizer

The thermally conductive compositions of the present invention may include a plasticizer component to adjust the viscosity of the dispensable mass, particularly under shear, and to maintain solid state and melt viscosities within desired ranges. Plasticizers useful in the present compositions are those which are effective in facilitating fluency of the coherent mass making up the composition. The plasticizers used in the compositions of the present invention may preferably be low-volatility liquids that reduce the viscosity of the composition. In some embodiments, the plasticizer may exhibit a viscosity of less than 1000 cP at 25° C. In another embodiment, the plasticizer may exhibit a viscosity of less than 500 cP at 25° C. In a further embodiment, the plasticizer may exhibit a viscosity of less than 100 cP at 25° C.

In some embodiments, the plasticizer may represent about 0.1 to about 25 percent by weight of the composition. In some embodiments, the plasticizer may represent about 0.5 to about 10 percent by weight of the composition. In some embodiments, the plasticizer may represent about 0.5 to about 5 percent by weight of the composition. The plasticizer may preferably be present at less than 20 percent by weight of the composition.

Example plasticizers include sebacates, adipates, terephthalates, dibenzoates, gluterates, phthalates, azelates, benzoates, sulfonamides, organophosphates, glycols, polyethers, trimellitates, polybutadienes, epoxies, amines, acrylates, thiols, polyols, and isocyanates. A preferred plasticizer is a trimellitate.

### Complimentary Antioxidants

In addition to the primary and secondary antioxidants described above, the compositions of the present invention may include additional antioxidant components that are functionally complimentary to the primary and secondary antioxidants, but different from the primary and secondary antioxidants described above. In some embodiments, the compositions of the present invention may include one or more complimentary primary-type and secondary-type antioxidants that are different than the primary and secondary antioxidants described above. Typical complimentary antioxidants include hindered phenols and secondary aromatic amines. An example sterically hindered phenol useful as a complimentary antioxidant in the compositions of the present invention is Irganox® 1010 from BASF Corporation. Metal deactivating antioxidants may also be used in the compositions of the present invention, with an example being Irganox® MD 1024 from BASF Corporation.

In some embodiments, the thermally conductive compositions of the present invention may include one or more complimentary antioxidants at a concentration of between 0.01 and 10 percent by weight of the composition. In some embodiments, the thermally conductive compositions of the present invention may include one or more complimentary antioxidants at a concentration of between 0.05 and 5 percent by weight of the composition. In some embodiments, the thermally conductive compositions of the present invention may include one or more complimentary antioxidants at a concentration of between 0.1 and 3 percent by weight of the composition.

### Optional Additives

In accordance with some embodiments of the present invention, the compositions described herein may further comprise one or more additives such as stabilizers, dispersing agents, coloring agents, adhesives, wetting agents, flame retardants, extenders, and corrosion inhibitors.

### Thermally Conductive Composition Properties

In preferred embodiments, the thermally conductive composition exhibits a thermal conductivity of at least 0.5 W/m*K, preferably at least 1 W/m*K, and more preferably at least 2 W/m*K. Moreover, the thermally conductive composition exhibits high temperature stability, experiencing less than 20% weight loss after 1000 hours at 175° C., and preferably less than 10% weight loss after 1000 hours at 175° C. The thermally conductive composition preferably experiences less than 10% degradation of thermal performance, such as thermal conductivity or thermal impedance, after 1000 hours at 175° C., and more preferably less than 5% degradation of thermal performance after 1000 hours at 175° C.

### Articles

The thermally conductive compositions of the present invention may be used to make a variety of shaped articles. The articles may be employed as interfaces between a heat-generating device and a heat-dissipating device. The heat-generating device operatively transfers heat to the interface article, causing the interface article to melt at operating temperatures below 120° C., and more often below 85° C. As the phase change material melts, it forms a liquid film at the contact surfaces of the interface article, electronic component, and heat dissipater. The film comprising the phase change material lowers the thermal resistance of the contact surfaces. The resin matrix of the thermally conductive interface provides a network for containing the liquid phase change material and prevents it from flowing out of the interface.

The composition may be melt-extruded into a film with a low thickness. By contrast, conventional films made from silicone-based filler compositions are generally much thicker. It has been found that non-silicone resin films may be advantageous over silicone version for certain applications. For example, thin silicone films tend to have poor handling characteristics, and may require support structures to maintain integrity. Moreover, silicone resins and particulate filler materials may be incompatible due to different densities and a low viscosity of the silicone resin. Thus, the compositions of the present invention are preferably non-silicone.

### Printable Compositions

In some embodiments, the thermally conductive compositions of the present invention may be printable through conventional printing equipment such as inkjet printers, fused filament printers, and other three-dimensional printers. In some embodiments, the compositions of the present invention may be melt-extruded through a print head or die. In other embodiments, the compositions of the present invention may be dissolved or suspended in a solvent or suspension fluid, and subsequently dispensed through an appropriate nozzle or slot. Solvent-based printing may be performed by printing the solution or suspension/dispersion onto a substrate, followed by drying the solvent at or above room temperature and/or at reduced pressure. Although a variety of solvents are contemplated as being useful for this purpose, acetate-based solvents such as ethyl acetate and ethylhexyl acetate are suitable solvents.

### EXAMPLES

The following compositions were prepared and exhibit the thermally conductive composition properties described herein.

### Example 1

| Material | % by weight |
|---|---|
| Thermoplastic resin | 1-10 |
| Primary antioxidant | 0.05-0.2 |
| Secondary antioxidant/ | 0.5-5 |
| Phase Change Material | |
| (didodecyl 3,3′-thiodipropionate) | |
| Trimellitate-based plasticizer | 0.5-5 |
| Wetting agent | 0.2-2 |
| Zinc Oxide | 20-30 |
| Aluminum Nitride | 20-30 |
| Aluminum Silica alloy | 40-50 |
| Complimentary Antioxidant | 0.1-1 |

### Example 2

| Material | % by weight |
|---|---|
| Thermoplastic Resin | 1-10 |
| Primary antioxidant | 0.05-2 |
| Secondary antioxidant/ | 0.5-5 |
| Phase Change Material | |
| (didodecyl 3,3′-thiodipropionate) | |
| Trimellitate-based plasticizer | 0.5-5 |
| Wetting agent | 0.2-2 |
| Zinc Oxide | 18-26 |
| Aluminum Nitride | 18-26 |
| Aluminum Silica alloy | 35-45 |
| Complimentary Antioxidant | 0.1-1 |
| Solvent | 5-15 |

1. A thermally conductive composition, comprising:
between 0.5 and 20 percent by weight of a non-silicone resin;
a primary antioxidant;
a thiol-based secondary antioxidant that is compatible with the primary antioxidant and present in the composition at a concentration of between 20 and 50 percent by weight of the non-silicone resin, the secondary antioxidant further being present in the composition in a ratio of between 95-99 parts by weight secondary antioxidant to between 1-5 parts by weight primary antioxidant, the secondary antioxidant having a melting point temperature of between 4° and 85° C.; and
between 50 and 98 percent by weight of thermally conductive particulate filler,
wherein the thermally conductive composition exhibits a thermal conductivity of at least 1 W/m*K, and less than 20% weight loss after 1000 hours at 175° C.

2. The thermally conductive composition as in claim 1 wherein the non-silicone resin includes a pressure sensitive adhesive.

3. The thermally conductive composition as in claim 1, including between 0.5 and 5 percent by weight of the non-silicone resin.

4. The thermally conductive composition as in claim 3 wherein the non-silicone resin includes polyamide.

5. The thermally conductive composition as in claim 1, including a hydrocarbon wax having a melting point temperature of between 4° and 120° C.

6. The thermally conductive composition as in claim 1 wherein the composition is substantially free from a wax.

7. The thermally conductive composition as in claim 1 wherein the melting point temperature of the secondary oxidant is between 5° and 60° C.

8. The thermally conductive composition as in claim 1 wherein the secondary antioxidant includes dodecylthiopropionate.

9. The thermally conductive composition as in claim 1 wherein the thermally conductive particulate filler is selected from aluminum, aluminum nitride, aluminum silica alloy, zinc oxide, and combinations thereof.

10. The thermally conductive composition as in claim 9 wherein the thermally conductive particulate filler has an average particle size (d₅₀) of less than 25 μm.

11. The thermally conductive composition as in claim 10, including between 70 and 95 percent by weight of the thermally conductive particulate filler.

12. The thermally conductive composition as in claim 1, including between 0.5 and 20 percent by weight of a trimellitate plasticizer.

13. The thermally conductive composition as in claim 12, including between 0.5 and 5 percent by weight of the trimellitate plasticizer.

14. The thermally conductive composition as in claim 13, including between 0.1 and 1.5 percent by weight of a wetting agent.

15. The thermally conductive composition as in claim 14, including between 0.1 and 1.5 percent by weight of a sterically hindered phenolic antioxidant that is different from the primary and the secondary antioxidants.

16. The thermally conductive composition as in claim 15, including between 0.1 and 1.5 percent by weight of a metal deactivator antioxidant that is different from the primary and the secondary antioxidants.

17. A thermally conductive printable composition, comprising:
the thermally conductive composition as in claim 1 dissolved in a compatible solvent.

18. The thermally conductive printable composition as in claim 17 wherein the solvent is selected from ethyl acetate and ethylhexyl acetate.
